(19) United States
(12) Patent Application Publication
(10) Pub. No.: US 2015/0046862 A1
(43) Pub. Date: Feb. 12, 2015

(54) MODIFYING BINNING OPERATIONS

(71) Applicant: Silicon Graphics International Corp., Milpitas, CA (US)

(72) Inventor: Marc David Hansen, Morgan Hill, CA (US)

(73) Assignee: Silicon Graphics International Corp., Milpitas, CA (US)

(21) Appl. No.: 14/042,725

(22) Filed: Oct. 1, 2013

Related U.S. Application Data
(60) Provisional application No. 61/864,586, filed on Aug. 11, 2013.

(51) Int. Cl. G06F 3/0484

(52) U.S. Cl. CPC G06F 3/0484
USPC 715/771

(57) ABSTRACT

A data visualization technique is provided with the capability of manipulating bins of data through an interactive graphical presentation of displayed data. When a histogram is generated from stored data, a user may interact directly with the histogram columns to change columns position, width and height. A user, for example, may click and drag a particular side of a bin to change the lower or upper limit of the bin, click and drag the top of a bin to change the size/height of the bin (i.e., number of data points/elements within the bin), or click and drag the center of the bin to move or reposition the bin. The techniques may be applied to other graphical representations of data as well, such as splat graphical displays of data.

### CROSS-REFERENCE TO RELATED APPLICATIONS

This application claims the priority benefit of U.S. provisional application No. 61/864,586, titled “Modifying Binning Operations,” filed Aug. 11, 2013, the disclosure of which is incorporated herein by reference.

### BACKGROUND

1. Field of the Invention

The presently claimed invention relates to data visualization. In particular, the presently claimed invention relates to binning operations for interactive data visualization.

2. Description of the Prior Art

Visualization of data in graphs can be helpful to understand a data set and/or analysis of such data. Examples of commonly used graphs include scatterplots, bar charts, and histograms. Various tools or products exist in the art that allow a user to visualize a set of data and its analysis and change or adjust the results of the data to gain deeper insight into the analysis. These data manipulation tasks may be labor-intensive and time consuming. With big data applications becoming increasingly popular, there is a need to improve the efficiency of data analysis and visualization.

### BRIEF DESCRIPTION OF THE DRAWINGS

FIG. 1 is a system for processing and visualizing data.

FIG. 2 is a method for processing and visualization data.

FIG. 3 is a method for manipulating a bin operation in a histogram.

FIG. 4 illustrates an interactive interface with a histogram.

FIGS. 5A-5F illustrate interfaces for adjusting display of binned data in a histogram.

FIG. 6 provides a computing device for implementing the present technology.

### DETAILED DESCRIPTION

The present technology may provide a system and method for data visualization with the capability of manipulating data bins associated with a histogram. Once a histogram is generated from data stored in a database and displayed to a user, a user may interact directly with the histogram. A user may specify a desired outcome of the data in the histogram by selecting one or more bins for adjustment or manipulation. A user may alter bin boundaries and change the range of columns to make a visualization more meaningful, for example, by creating bins with similar attribute label ratios. A user, for example, may click and drag a particular side of a bin to change the lower or upper limit of the bin, click and drag the top of a bin to change the size/height of the bin (i.e., number of data points/elements within the bin), or click and drag the center of the bin to move or reposition the bin. Clicking in the center of a bin and dragging upward could remove the bin. The system could then automatically re-bin the data into the new number of bins.

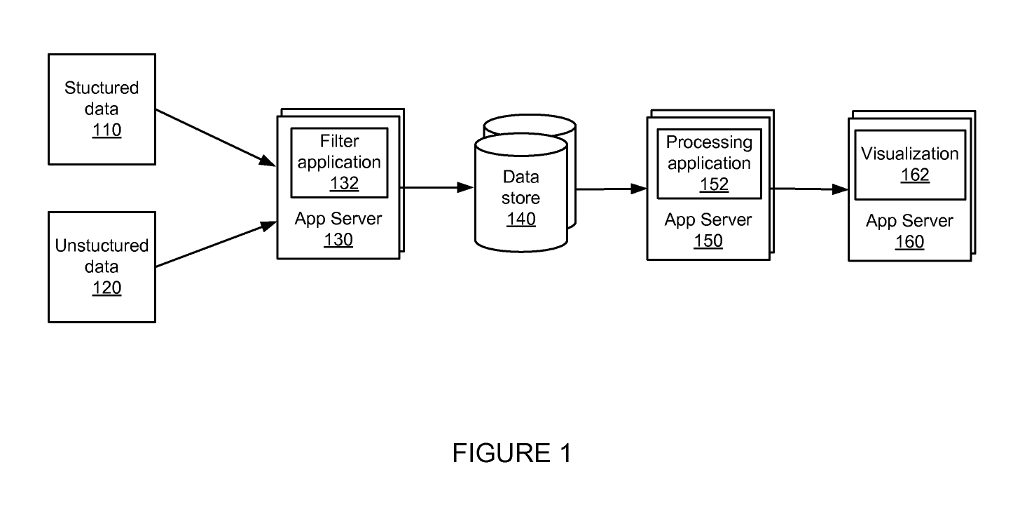

FIG. 1 is a system for processing and visualizing data. The system of FIG. 1 includes structured data 110, unstructured data 120, application servers 130, 150 and 160, and data store 140. The system may also include semi-structured data (not pictured). Structured data 110 (RDMS data) may include data items stored in tables. The structured data may be stored in a relational database, and may be formally described and organized according to a relational model. Structured data 110 may be data which can be managed using a relational database management system and may be accessed by application server 130.

Unstructured data may include data that does not include a predefined data model or does not fit into relational tables as structured data 110. Unstructured data may include text, dates, numbers, facts and other data, including email, media and documents. Unstructured data may also include lists or other data associated with web page clicks, shopping cart data, and other data. Unstructured data may be accessed by application server 130.

Application server may include one or more servers that receive and access structured data 110 and unstructured data 120. Filter application 132 may be stored and executed on application server 130, and may be executed to ingest the structured and unstructured data. Filter application 132 may apply filters, intelligence, or other processes to select a subset of the data received and/or accessed.

Data store 140 may include one or more data stores that receive data which has been filtered by filter application 132. Data stores 140 may include SQL servers, NoSQL servers, and other servers. The data may be stored in these servers until they are accessed for processing.

Application server 150 may include one or more servers which receive and/or access data stored in data store 140. Processing application 152 may be stored on application server 150. When executed, processing application 152 may access filtered data from data store 140 and analyze the data for trends, patterns, a particular data of interest, or other data desired for reporting. For example, processing application 152 may be implemented by “Apache Hadoop” software, which is an open source software application that provides a distributed application for analyzing data.

Once data is analyzed, visualization program 162 located on application server 160 may report the data to a user. The data may be provided in many forms, such as reports, visualizations, and other formats. For example, visualization application 162 may provide data in a three dimensional graphical visualization format. In some embodiments, processing application 152 and visualization module 162 may be implemented as part of a client server tool set for extracting data, mining data with analytical algorithms, and providing interactive visualization input.

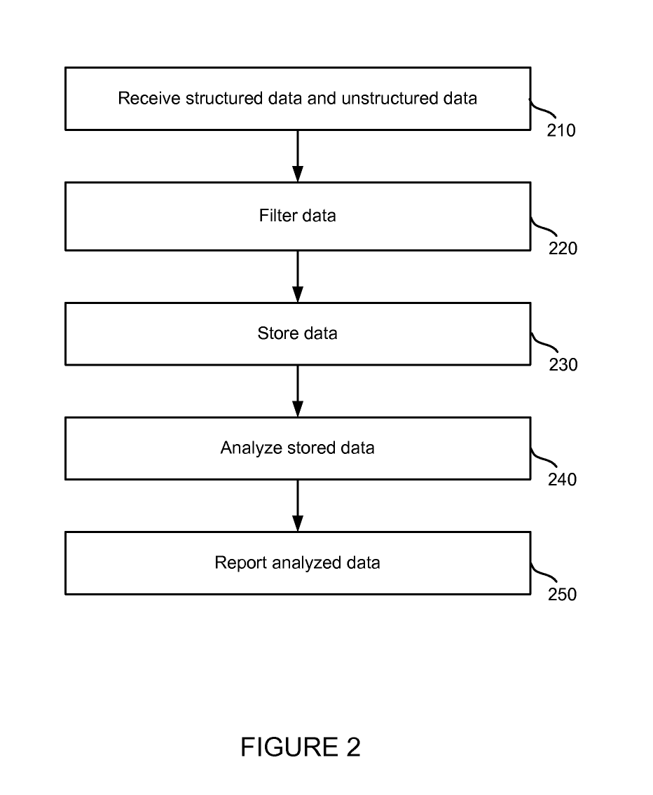

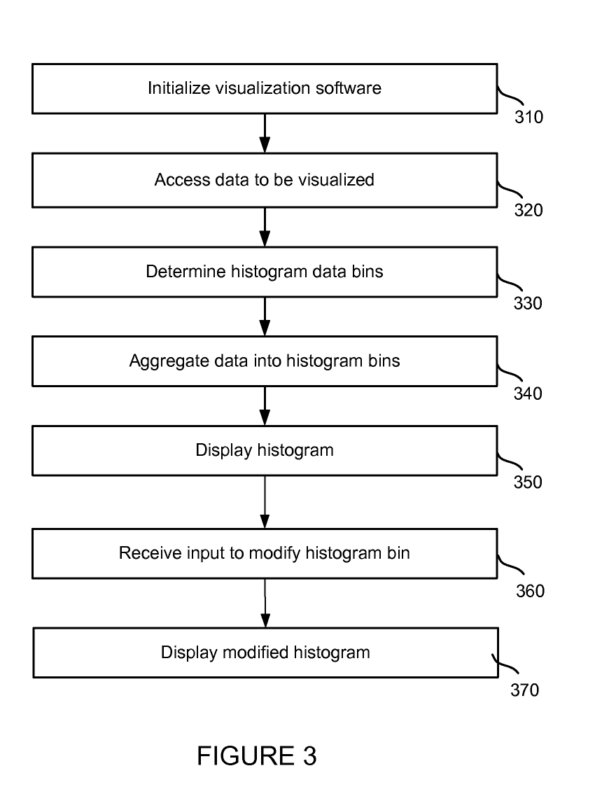

FIGS. 2-3 illustrate methods for performing functionality described herein. The steps identified in FIGS. 2-3 (and the order thereof) are exemplary and may include various alternatives, equivalents, or derivations thereof including but not limited to the order of execution of the same. The steps of the method of FIGS. 2-3 (and its various alternatives) may be embodied in hardware or software including a computer-readable storage medium (e.g., optical disc, memory card, etc.) comprising instructions executable by a processor of a computing device.

FIG. 2 is a method for analyzing and reporting data. The method of FIG. 2 may be performed by the system of FIG. 1. First, structured data and unstructured data may be received at step 210. The data may be received by filter application 132 on application server 130. The received data may be filtered at step 220. Filter application 132 may filter the data by time sampling, applying intelligence, and other methods to result in a subset of the entire set of the received data.

Filtered data may be stored at step 230. The data may be stored based on the type of data it is. For example, structured data may be stored in a SQL database and unstructured data may be stored in a NoSQL database. The stored data may be analyzed at step 240. Analyzing the data may include looking for trends, patterns, or otherwise processing the stored data to determine a subset of data to report to a user. Analyzing the data may be performed by processing application 152 on application server 150. Once the stored data is analyzed, the data can be reported at step 250. The data may be reported through an interactive visualization, reports, or other methods that may be useful to a user. The visualization may present a three dimensional graph of data and provide data in histograms. Step 250 is discussed in more detail with respect to FIG. 3.

FIG. 3 is a method for providing a visualization of data. The method of FIG. 3 may provide more detail for step 250 of the method of FIG. 2. In embodiments, visualization application 162 may perform the steps of FIG. 3. The visualization application 162 may extract stored data, mine data for desired information, and provide an interactive visualization of the data.

At step 310, visualization software is initialized. Initializing the data may include executing the software, identifying what data to retrieve, and other configurations of the software. Data to be visualized may be accessed at step 320. The data may be accessed locally or remotely, for example from data store 140.

Histogram bins may be determined at step 330. Each histogram bin may be associated with a range of data stored in a database. A data point, for example, is associated with, grouped, or placed in a particular histogram bin if the data point value is within a particular value range associated with the bin. The number of bins in the histogram may depend on the value ranges of the data to be visualized, the desired detail to convey in the visualization, user preference, and other factors.

In one embodiment, once a number of bins is selected, bin ranges may be selected by dividing the axis length by the number of bins. For example, if an axis was to cover data values ranging from 0 to 1000 units on a screen, and there were 20 bins to display on the axis, each bin would have a range of 50 units. Bins may also have different ranges, if desired. For example, one or more bins may have a larger range or narrower range based on the frequency of data values, weighting of bins, and other factors. Bin operations may be uniform or non-uniform. In one embodiment, bin thresholds are automatically suggested or selected using machine learning or other techniques known in the art. In another embodiment, a user may manually select or designate a bin threshold (start and end) and the size of each bin.

After histogram data bins are determined, data is aggregated into the histogram bins at step 340. The values from every data point are used to populate the appropriate bin. For example, if an attribute had values of [4, 14, 21], and the corresponding histogram had bin ranges of 0-9, 10-19, and 20-29, the [0-9] bin count would be incremented for the first data point from the [4] value, the [10-19] bin count would be incremented for the second data point from the [14] value, and the [20-29] bin count would be incremented for the third data point from the [21] value. The resulting histogram bins may be displayed to a user for analysis and manipulation. Circular binning may be used for cyclical data such as data for degrees or time (e.g. hours, months, etc.).

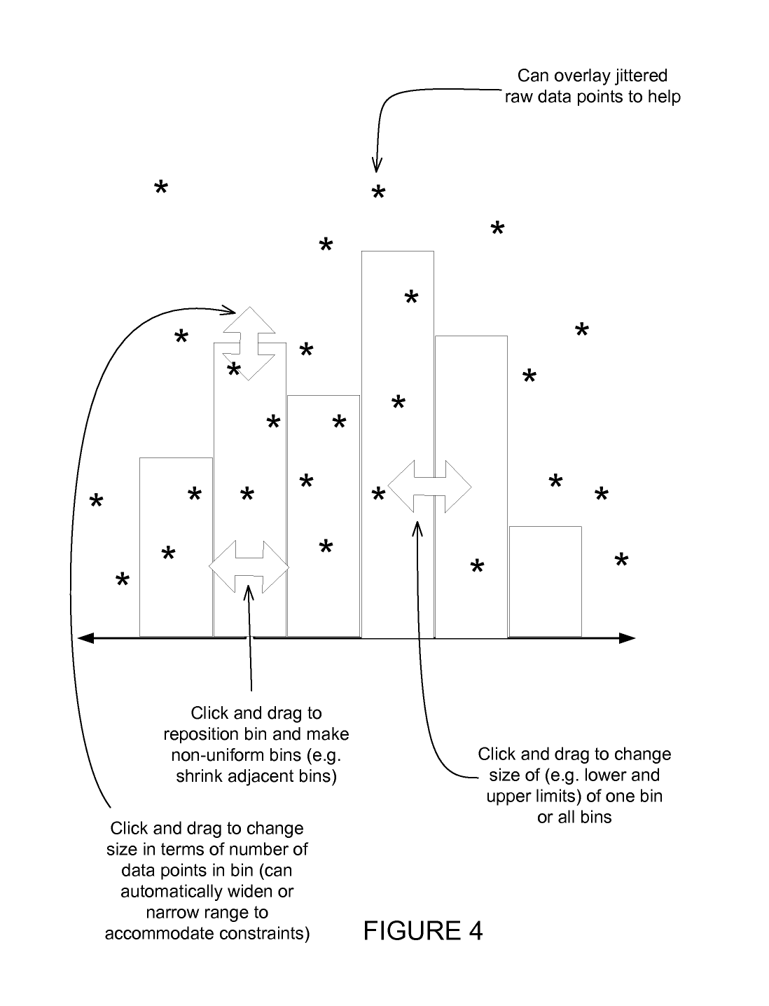

After aggregating the data into the histogram bins, the histogram data is displayed at step 350. An example of a histogram is displayed in FIG. 4. The histogram may show results from non-numeric (i.e. strings) or numeric data. Once a histogram is generated, a user may directly interact with the histogram. For example, in one embodiment, a user may click and drag a cursor or pointer using a peripheral device (e.g., a stylus or computer mouse) over particular points or portions of the histogram to make an adjustment or modification to how the data should be visualized. In another embodiment, a user may directly touch a display screen presenting the histogram.

At step 360, a user input associated with modifying a histogram bin is received. FIG. 4 illustrates an interactive interface with a histogram. User input may be used to adjust the size of bins of data and corresponding histogram. The input may include clicking and dragging portions of the interface to change the size (e.g., lower and upper limits) of one bin or a plurality of bins, clicking and dragging to reposition a bin and select non-uniform bins, or clicking and dragging to change the size in terms of number of data points in a bin. For example, in changing the number of data points, a data range may be automatically widened or narrowed to accommodate constraints. At step 370, the modified histogram (i.e. with one or more modified or adjusted bins) is displayed to the user.

The presently claimed invention relating to data bins is not limited to histograms but may apply to other visualizations of aggregated data points known in the art such as those involving splats. A user, for example, may interact with a splat visualization to change the width in any dimension of a particular splat. Details regarding graphics involving splats are discussed in U.S. utility patent application Ser. No. 13/931,797, filed Jun. 28, 2013 entitled “Volume Rendering for Graph Renderization,”, which is incorporated herein by reference. The presently claimed invention may also apply to histograms involving parallel coordinates such as those described in U.S. utility patent application Ser. No. 13/931,785 filed Jun. 28, 2013 entitled “Combining Parallel Coordinates and Histograms” which is incorporated herein by reference in its entirety.

In one embodiment, a histogram may be overlaid with jittered raw data. For example, a data point falling within a bin may be plotted as a dot or other acceptable shape, graphic, or mark in the bin. A second data point might have the same value, and may be drawn or positioned slightly away from the first data point (i.e., jittered above, or below) to avoid overplotting. These overlaid data points may help the user in deciding the number and shape of the bins to create.

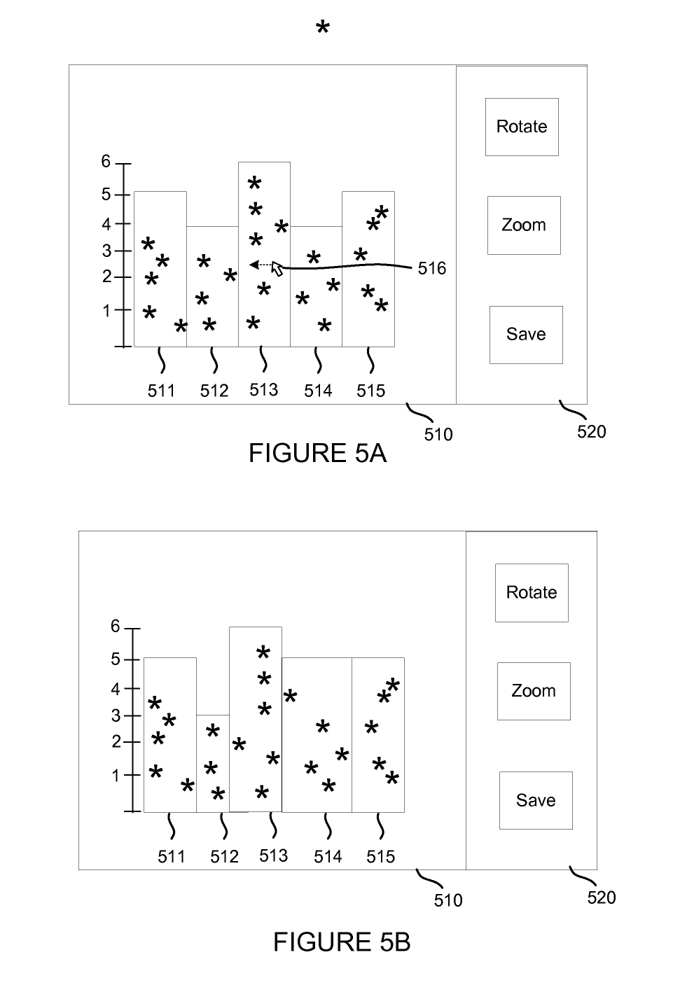

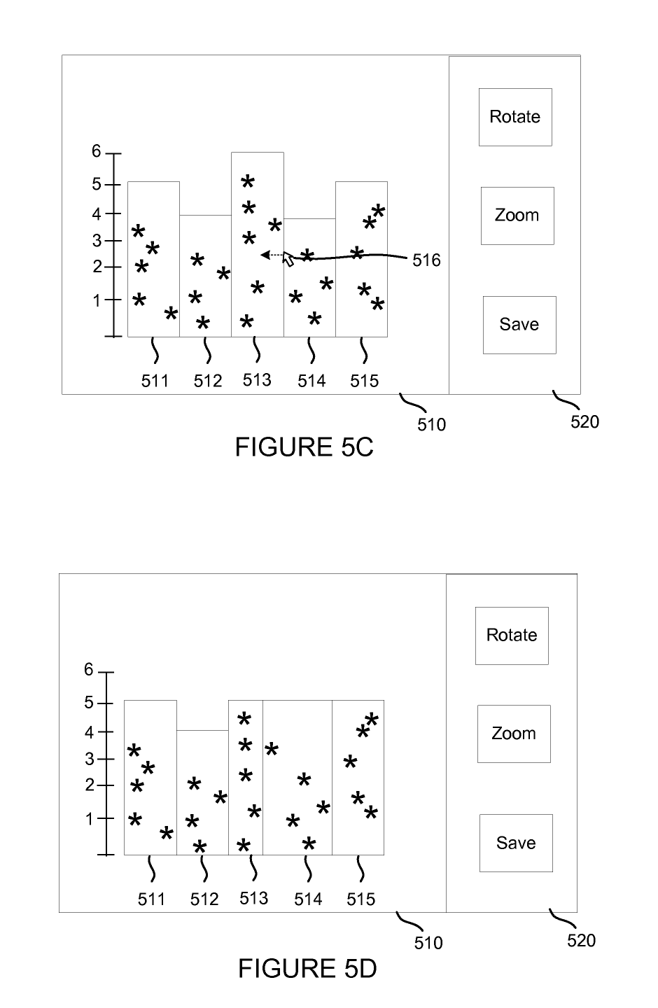

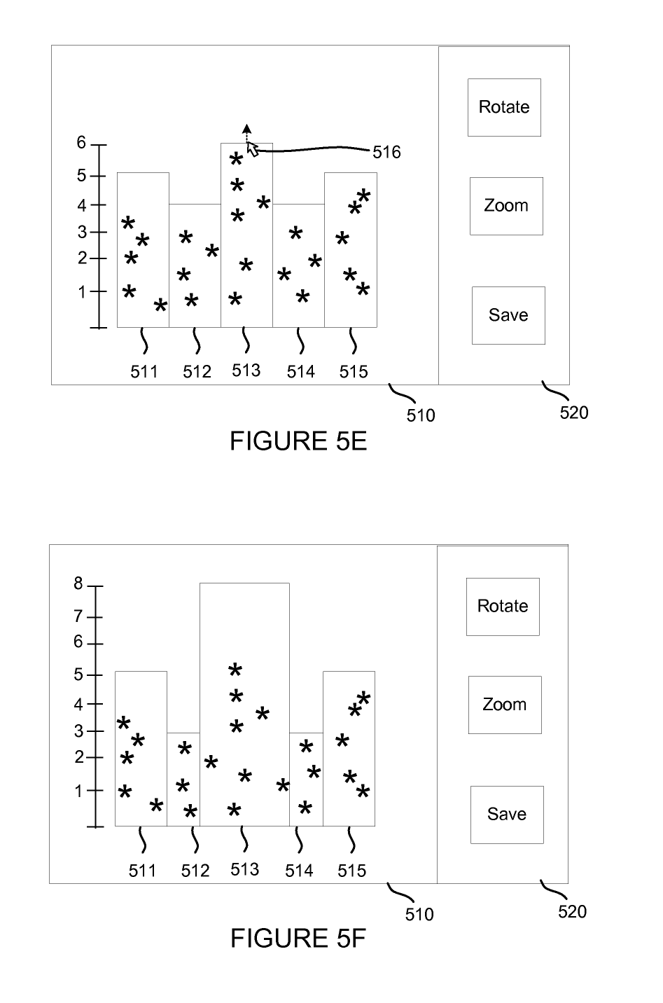

FIGS. 5A-5F illustrate interfaces for adjusting display of binned data in a histogram. The interfaces of FIGS. 5A-B illustrate a histogram wherein the range of a selected bin of a plurality of bins is kept the same in size but reduced in value. The interface of FIG. 5A includes graphical portion 510 and control portion 520. Control portion 520 includes one or more selectable buttons for functions such as “rotate”, “zoom”, and “save.” Graphical portion 510 includes a histogram with columns 511, 512, 513, 514, and 515. Each of the columns has a uniform width, as may be the case when they are initially constructed. Within the graphical portion, a user may select a column and move the column to the left or the right to move the column within the interface. For example, a user may move column 513 to the left by placing cursor 516 within the column and dragging the column to the left. The results of dragging a column to a new position are illustrated in FIG. 5B. Column 513 may be positioned to the left of its previous position, and remains the same width (i.e., it has the same range) as it did before the column was moved. Column 512 to the left of column 513 decreases in width due to the changed position and decreases in height due to the fewer data points that fall into the reduced bin size (i.e., width) of column 512. Column 514 has an increased width (and corresponding bin size) due to the move of its neighboring column away from it. Because more data points fall within the bin of column 514 in FIG. 5B than that of FIG. 5A, the height of column 514 is higher in FIG. 5B than in FIG. 5A. The change in position of column 513 does not affect the bin size of column 513 but does affect the range values of column 513. However the bin size of neighboring columns 512 and 514 are decreased and increased, respectively. The change in height of each column is a result of the changes in range values and bin sizes.

FIGS. 5C-5D illustrate interfaces wherein a histogram column edge may be adjusted. In FIG. 5C, a user may provide input in graphical portion 510 to select the edge between columns 513 and 514 using cursor 516. The column can be adjusted in the horizontal direction to the left or the right. The interface of FIG. 5D illustrates a histogram after the edge between columns 513 and 514 have been adjusted to the left. As shown, the width of column 513 is shorter and the width of column 514 is longer. Because fewer data points lie within the width of column 513 in FIG. 5D as compared to FIG. 5C, the height of column 513 is shorter in FIG. 5D than in FIG. 5C. Because more data points lie within the width of column 514 in FIG. 5D as compared to FIG. 5C, the height of column 514 is taller in FIG. 5D than in FIG. 5C. The input to move the column edge affects the bin size of both columns 513 and 514. The height changes for each of these columns are a result of the data that falls into the new bins for each column.

FIGS. 5E-5F illustrate interfaces wherein a histogram column height may be adjusted. In FIG. 5E, a user may provide input in graphical portion 510 to select the top edge of columns 513 using cursor 516. The column can be adjusted in the vertical direction to drag the column upper edge downward or upward in the interface. The interface of FIG. 5F illustrates a histogram after the upper edge of columns 513 has been adjusted upward. As shown, the width of column 513 is larger. Because more data points lie within the width of column 513 in FIG. 5F as compared to FIG. 5E, the height of column 513 is taller in FIG. 5F than in FIG. 5E. The heights of neighboring columns 512 and 514 are decreased.

The embodiments discussed with respect to FIGS. 5A-F involve a linear representation of data. In addition to modifying a graphical representation of data in a linear scale, changes to data bins can also be applied to non-linear scales. For example, instead of the scale on the horizontal axis being 0, 10, 20 and so forth, the scale could be: 0, 10, 100, 1000, and so forth, where the distance between 0 and 10 is the same distance within the interface as from 10-100. Hence, the features herein may be applied to log-linear or semi-log scaling, and may be applied along a Y or count axis, or in other coordinates, depending on the data distribution.

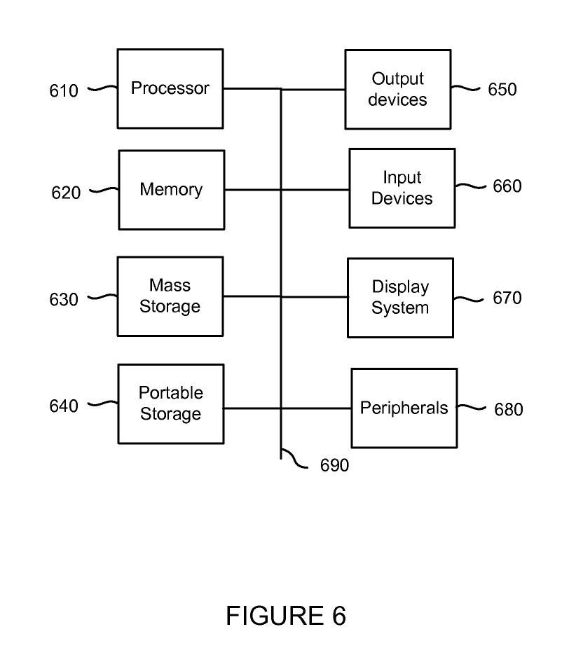

FIG. 6 illustrates a computing device for implementing the present technology. Computing device 600 may be used to implement devices such as application servers 130, 150 and 160 and data stores 140. System 600 of FIG. 6 may be implemented in the contexts of the likes of client computer 210, servers that comprise services 230-250 and 270-280, application server 260, and data store 267. The computing system600 of FIG. 6 includes one or more processors610 and memory620. Main memory620 stores, in part, instructions and data for execution by processor610. Main memory 620 can store the executable code when in operation. The system 600 of FIG. 6 further includes a mass storage device 630, portable storage medium drive(s)640, output devices 650, user input devices 660, a graphics display670, and peripheral devices 680.

The components shown in FIG. 6 are depicted as being connected via a single bus690. However, the components may be connected through one or more data transport means. For example, processor unit610 and main memory620 may be connected via a local microprocessor bus, and the mass storage device630, peripheral device(s)680, portable storage device640, and display system670 may be connected via one or more input/output (I/O) buses.

Mass storage device 630, which may be implemented with a magnetic disk drive or an optical disk drive, is a non-volatile storage device for storing data and instructions for use by processor unit610. Mass storage device630 can store the system software for implementing embodiments of the present invention for purposes of loading that software into main memory 620.

Portable storage device640 operates in conjunction with a portable non-volatile storage medium, such as a floppy disk, compact disk or Digital video disc, to input and output data and code to and from the computer system600 of FIG. 6. The system software for implementing embodiments of the present invention may be stored on such a portable medium and input to the computer system600 via the portable storage device640.

Input devices660 provide a portion of a user interface. Input devices660 may include an alpha-numeric keypad, such as a keyboard, for inputting alpha-numeric and other information, or a pointing device, such as a mouse, a trackball, stylus, or cursor direction keys. Additionally, the system600 as shown in FIG. 6 includes output devices650. Examples of suitable output devices include speakers, printers, network interfaces, and monitors.

Display system 670 may include a liquid crystal display (LCD) or other suitable display device. Display system 670 receives textual and graphical information, and processes the information for output to the display device.

Peripherals 680 may include any type of computer support device to add additional functionality to the computer system. For example, peripheral device(s) 680 may include a modem or a router.

The components contained in the computer system 600 of FIG. 6 are those typically found in computer systems that may be suitable for use with embodiments of the present invention and are intended to represent a broad category of such computer components that are well known in the art. Thus, the computer system 600 of FIG. 6 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, and other suitable operating systems.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A method for displaying data, comprising:
providing a histogram within a graphical portion of an interface, the histogram including a plurality of columns, each column representing a number of data points within a data range corresponding to the particular column;
receiving input within the graphical portion of the interface to adjust a column of the histogram; and
updating the histogram with the plurality of columns in the interface, the updated histogram including two or more updated columns based on the received input.

2. The method of claim 1, wherein the input is received by manipulating the position of a cursor displayed within the graphical portion of the interface.

3. The method of claim 1, wherein the input includes adjusting the position of a column within the histogram.

4. The method of claim 3, wherein the column with the adjusted position does not change in width.

5. The method of claim 3, wherein a column adjacent to the column with an adjusted position is updated with an adjusted width.

6. The method of claim 1, wherein the input includes adjusting an edge of a column.

7. The method of claim 6, wherein a column adjacent to the column with an adjusted edge is updated with an adjusted width.

8. The method of claim 1, wherein the input includes adjusting the height of a column.

9. The method of claim 8, wherein a column adjacent to the column with an adjusted height is updated with an adjusted width.

10. The method of claim 1, further comprising displaying data points in the graphical portion.

11. A method for displaying data, comprising:
providing a graphical representation of a plurality of data groups within a graphical portion of an interface, the graphical representation including a plurality of data groupings representing a number of data points within a data range corresponding to the particular data group;
receiving input within the graphical portion of the interface to adjust an area of a data grouping; and
updating the graphical representation with the plurality of data groupings in the interface, the updated data groupings including two or more updated data grouping based on the received input.

12. The method of claim 11, wherein a data grouping is a column in a histogram.

13. The method of claim 11, wherein a data grouping is a splat in a series of splats.

14. The method of claim 11, wherein the input adjusts the area covered by a particular splat.

15. A computer readable storage medium having embodied thereon a program, the program being executable by a processor to perform a method for displaying data, the method comprising:
providing a histogram within a graphical portion of an interface, the histogram including a plurality of columns, each column representing a number of data points within a data range corresponding to the particular column;
receiving input within the graphical portion of the interface to adjust a column of the histogram; and
updating the histogram with the plurality of columns in the interface, the updated histogram including two or more updated columns based on the received input.

16. The computer readable storage medium of claim 15, wherein the input is received by manipulating the position of a cursor displayed within the graphical portion of the interface.

17. The computer readable storage medium of claim 15, wherein the input includes adjusting the position of a column within the histogram.

18. The computer readable storage medium of claim 17, wherein the column with the adjusted position does not change in width.

19. The computer readable storage medium of claim 17, wherein a column adjacent to the column with an adjusted position is updated with an adjusted width.

20. The computer readable storage medium of claim 15, wherein the input includes adjusting an edge of a column.

21. The computer readable storage medium of claim 20, wherein a column adjacent to the column with an adjusted edge is updated with an adjusted width.

22. The computer readable storage medium of claim 15, wherein the input includes adjusting the height of a column.

23. The computer readable storage medium of claim 23, wherein a column adjacent to the column with an adjusted height is updated with an adjusted width.

24. The computer readable storage medium of claim 15, further comprising displaying data points in the graphical portion.

25. A computer readable storage medium having embodied thereon a program, the program being executable by a processor to perform a method for displaying data, the method comprising:
providing a graphical representation of a plurality of data groups within a graphical portion of an interface, the graphical representation including a plurality of data groupings representing a number of data points within a data range corresponding to the particular data group;
receiving input within the graphical portion of the interface to adjust an area of a data grouping; and
updating the graphical representation with the plurality of data groupings in the interface, the updated data groupings including two or more updated data grouping based on the received input.

26. The method of claim 25, wherein a data grouping is a column in a histogram.

27. The method of claim 25, wherein a data grouping is a splat in a series of splats.

28. The method of claim 25, wherein the input adjusts the area covered by a particular splat.

29. A system for displaying data, comprising:
a processor;
memory; and
one or more modules stored in memory and executed by the processor to provide a histogram within a graphical portion of an interface, the histogram including a plurality of columns, each column representing a number of data points within a data range corresponding to the particular column, receive input within the graphical portion of the interface to adjust a column of the histogram, and update the histogram with the plurality of columns in the interface, the updated histogram including two or more updated columns based on the received input.

30. The system of claim 29, wherein the input is received by manipulating the position of a cursor displayed within the graphical portion of the interface.

31. The system of claim 29, wherein the input includes adjusting the position of a column within the histogram.

32. The system of claim 31, wherein the column with the adjusted position does not change in width.

33. The system of claim 31, wherein a column adjacent to the column with an adjusted position is updated with an adjusted width.

34. The system of claim 29, wherein the input includes adjusting an edge of a column.

35. The system of claim 34, wherein a column adjacent to the column with an adjusted edge is updated with an adjusted width.

36. The system of claim 29, wherein the input includes adjusting the height of a column.

37. The system of claim 36, wherein a column adjacent to the column with an adjusted height is updated with an adjusted width.

38. The system of claim 29, further comprising displaying data points in the graphical portion.

39. A system for displaying data, comprising:
a processor;
memory; and
one or more modules stored in memory and executed by the processor to provide a graphical representation of a plurality of data groups within a graphical portion of an interface, the graphical representation including a plurality of data groupings representing a number of data points within a data range corresponding to the particular data group, receive input within the graphical portion of the interface to adjust an area of a data grouping, and update the graphical representation with the plurality of data groupings in the interface, the updated data groupings including two or more updated data grouping based on the received input.

40. The system of claim 39, wherein a data grouping is a column in a histogram.

41. The system of claim 39, wherein a data grouping is a splat in a series of splats.

42. The system of claim 39, wherein the input adjusts the area covered by a particular splat.
